(19) United States
(12) Patent Application Publication
(10) Pub. No.: US 2011/0123699 A1
(43) Pub. Date: May 26, 2011

(54) PATTY COOKING APPARATUS

(76) Inventor: Carlos BELTRAN, Loveland, CO (US)

(21) Appl. No.: 12/914,707

(22) Filed: Oct. 28, 2010

Related U.S. Application Data
(60) Provisional application No. 61/255,849, filed on Oct. 28, 2009.

(51) Int. Cl. A23P 1/10; A23L 1/01

(52) U.S. Cl. 426/513; 99/426

(57) ABSTRACT

An apparatus for cooking a meat patty includes one or more cups, each sized for holding a quantity of meat. The apparatus further includes a cup holder configured to support the one or more cups during cooking and a reservoir tray. The reservoir tray is positioned below the one or more cups and is adapted to collect excess fat and grease draining from the one or more cups.

### CROSS-REFERENCE TO RELATED APPLICATION

The present application is a U.S. nonprovisional patent application of, and claims priority under 35 U.S.C. §119(e) to, U.S. provisional patent application Ser. No. 61/255,849, filed Oct. 28, 2009, which provisional patent application is incorporated by reference herein.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE INVENTION

The present invention generally relates to a cooking apparatus for meat patties and, more specifically, to a cooking apparatus for use in connection with the preparation and cooking of meat patties for hamburgers and the like.

Hamburgers and similar types of sandwiches are a common meal prepared in homes across many geographic areas. The meat for use in the preparation of the hamburger is typically prepared by a grilling process. Generally, grilling is performed outdoors; however, many geographic areas experience severe weather for portions of the year, thereby limiting the possibility of comfortably grilling outdoors. Furthermore, typical outdoor-style grills are rather expensive to purchase. An alternative to outdoor grilling is cooking indoors on a stovetop. Unfortunately, when meat such as hamburger and ground round is cooked on a stovetop, it tends to retain a large portion of fat and grease, thereby resulting in a less healthy burger. Moreover, cooking meat indoors on a stovetop can produce excessive smoke and unpleasant odors.

Accordingly, a need exists for improvement in meat patty preparation and cooking This, and other needs, are addressed by one or more aspects of the present invention.

### SUMMARY OF THE INVENTION

The present invention includes many aspects and features. Moreover, while many aspects and features relate to, and are described in, the context of preparation of meat patties for hamburgers and the like, the present invention is not limited to use only in connection with the preparation of meat patties for hamburgers, as will become apparent from the following summaries and detailed descriptions of aspects, features, and one or more embodiments of the present invention.

Broadly defined, the present invention according to a first aspect is an apparatus for cooking a meat patty substantially as shown and described.

Broadly defined, the present invention according to a second aspect is an apparatus for cooking a meat patty that includes a cooking tray having one or more cups, each sized for holding a quantity of meat, and a reservoir tray configured to support the cooking tray during cooking. The reservoir tray has one or more drainage channels to carry excess fat and grease away from the one or more cups and to a receptacle.

In features of this aspect, the cooking tray may have at least six cups; each of the one or more cups may have a generally cylindrical shape; each cup may have one or more protruding grooves situated at the bottom thereof; each cup may have at least four protruding grooves; the excess fat and grease may escape from the one or more cups via slits situated at or near the bottom of a side thereof; each cup may have four slits spaced generally evenly; the four slits of each cup may be aligned with drainage channels of the reservoir tray; the drainage channels may gradually decrease in elevation toward the receptacle; either or both of the cooking tray and the reservoir tray may include a non-stick material; and the apparatus may be usable in a baking oven.

Broadly defined, the present invention according to a third aspect is an apparatus for cooking a meat patty that includes one or more cups situated on a cooking surface, each sized for holding a quantity of meat; a receptacle configured to receive excess fat and grease during cooking; and a plurality of drainage channels configured to carry the excess fat and grease from the one or more cups to the receptacle.

In features of this aspect, the apparatus may be a unitary structure; the apparatus may have at least two cups; the apparatus may have at least six cups; each of the one or more cups may have a generally cylindrical shape; each cup may have one or more protruding grooves situated at the bottom thereof; each cup may have at least four protruding grooves; the excess fat and grease may escape from the one or more cups via slits situated at or near the bottom of a side thereof; each cup may have four slits spaced generally evenly; the four slits of each cup may be aligned with drainage channels; the drainage channels may gradually decrease in elevation toward the receptacle; the apparatus may include a non-stick material; and the apparatus may be usable in a baking oven.

Broadly defined, the present invention according to a fourth aspect is a method of cooking a meat patty substantially as shown and described.

Broadly defined, the present invention according to a fifth aspect is a method of cooking a meat patty with a meat patty apparatus. The method includes the steps of placing a quantity of meat in a cup of a cooking tray, wherein the cup has at least one slit at the base thereof; arranging the quantity of meat into the shape of a patty; positioning the cooking tray relative to a reservoir tray such that the at least one slit is generally aligned with at least one drainage channel of the reservoir tray; and placing the positioned cooking tray and reservoir tray in an oven for cooking, wherein excess fat and grease is permitted to escape via the at least one slit of the cup and is carried to a receptacle via the at least one drainage channel.

Broadly defined, the present invention according to a sixth aspect is a method of cooking a meat patty. The method includes the steps of placing a quantity of meat in a cup of a patty cooking apparatus, wherein the cup has at least one slit at the base thereof and at least one drainage channel corresponding to the slit; arranging the quantity of meat into the shape of a patty; and placing the patty cooking apparatus in an oven for cooking, wherein excess fat and grease is permitted to escape via the at least one slit of the cup and is carried to a receptacle via the at least one drainage channel.

Another aspect of the present invention relates to an apparatus for cooking meat patties. An exemplary such apparatus includes one or more cups, each sized for holding a quantity of meat, a cup holder, configured to support the one or more cups during cooking, and a reservoir tray. Furthermore, in this aspect of the invention the reservoir tray is positioned below the one or more cups and is adapted to collect excess fat and grease draining from the one or more cups.

In a feature of this aspect of the invention, each cup has one or more protruding grooves situated at a bottom portion thereof. In a variation of this feature, each cup includes exactly five protruding grooves. In another variation of this feature, each cup includes exactly seven protruding grooves.

In another feature of this aspect of the invention, the excess fat and grease escapes from the one or more cups via drainage openings situated at or near a bottom portion thereof. In a variation of this feature, each cup includes exactly eighteen drainage openings. In another variation of this feature, each cup includes exactly forty-six drainage openings.

In yet another feature of this aspect, the cup holder is a wire rack having one or more handle portions and one or more cup openings. In a variation of this feature, the cup holder includes exactly twelve cup openings. In another variation of this feature, the cup holder includes exactly six cup openings. In yet another variation of this feature, each cup opening is sized to fit around and secure a single cup.

In another feature of this aspect of the invention, each cup includes a grip portion and a storage cavity, and wherein the grip portion is adapted to assist placement of each cup in the cup holder. In a variation of this feature, each cup further includes a downwardly-extending protrusion to prevent the cup from sliding while supported in the cup holder.

In still another feature of this aspect of the invention, the apparatus further includes a wire connector, wherein the wire connector attaches a first cup to a second cup. In a variation of this feature, both the first cup and second cup include a handle, and wherein the handle is adapted to prevent the first cup and the second cup from sliding while supported in the cup holder.

In still another feature of this aspect of the invention, each of the one or more cups has a generally cylindrical shape. In a variation of this feature, the one or more cups has a diameter of approximately two and one-half inches and a depth of approximately two-thirds inch. In another variation of this feature, the one or more cups has a diameter of approximately four inches and a depth of approximately one inch.

Another aspect of the present invention relates to a method of cooking a meat patty with a meat patty cooking apparatus An exemplary such method includes the steps of placing a quantity of meat in a cup, wherein the cup has at least one drainage opening at the bottom thereof; arranging the quantity of meat into the shape of a patty; placing the cup in a cup holder device; placing the cup holding device relative to a reservoir tray such that the at least one drainage opening is above the reservoir tray; and placing the positioned cup holding device and reservoir tray in an oven for cooking, wherein excess fat and grease is permitted to escape via the at least one drainage opening of the cup and enter the reservoir tray.

In a feature of this aspect, the cup holding device is a wire rack with one or more cup openings, each cup opening adapted to hold a cup.

Another aspect of the present invention relates to an apparatus for cooking meat patties. An exemplary such apparatus includes one or more cups, each cup sized for holding a quantity of meat, and each cup having one or more protruding grooves situated at a bottom portion thereof, and one or more drainage openings situated at or near a bottom portion thereof. Such an apparatus further includes a cup holder comprising a wire rack having one or more cup openings, each cup opening configured to support a cup during cooking, and a reservoir tray. Furthermore, the reservoir tray is positioned below the one or more drainage openings such that excess fat and grease leaking from the one or more cups via the drainage openings will collect in the reservoir tray.

In addition to the aforementioned aspects and features of the present invention, it should be noted that the present invention further encompasses the various possible combinations and subcombinations of such aspects and features.

### BRIEF DESCRIPTION OF THE DRAWINGS

One or more preferred embodiments of the present invention now will be described in detail with reference to the accompanying drawings, wherein the same elements are referred to with the same reference numerals, and wherein,

FIG. 1 is a perspective view of a first embodiment of a patty cooking apparatus in accordance with one or more aspects of the present invention;

FIG. 2 is a top view of a cupped cooking tray as shown as part of the patty cooking apparatus of FIG. 1;

FIG. 3 is a front view of the cupped cooking tray of FIG. 2;

FIG. 4 is a cross-sectional view of the cupped cooking tray of FIG. 2, taken along line 4-4;

FIG. 5 is a top view of a reservoir tray as shown as part of the patty cooking apparatus of FIG. 1;

FIG. 6 is a front view of the reservoir tray of FIG. 5;

FIG. 7 is a cross-sectional view of the reservoir tray of FIG. 5, taken along line 7-7;

FIG. 8 is a perspective view of a second embodiment of a patty cooking apparatus in accordance with one or more aspects of the present invention;

FIG. 9 is a top view of the patty cooking apparatus of FIG. 8;

FIG. 10 is a front view of the patty cooking apparatus of FIG. 8;

FIG. 11A is a cross-sectional view of the patty cooking apparatus of FIG. 9, taken along line 11-11;

FIG. 11B is an enlarged view of a portion of FIG. 11A;

FIG. 12 is a cross-sectional view of the patty cooking apparatus of FIG. 9, taken along line 12-12;

FIG. 13 is a perspective view of a third embodiment of a patty cooking apparatus in accordance with one or more aspects of the present invention;

FIG. 14 is an isometric view of a fourth embodiment of a patty cooking apparatus, including a plurality of burger cups, in accordance with one or more aspects of the present invention;

FIG. 15 is a top view of the patty cooking apparatus of FIG. 14;

FIG. 16 is a front view of the patty cooking apparatus of FIG. 14;

FIG. 17 is a side view of the patty cooking apparatus of FIG. 14;

FIG. 18 is a cross-sectional view of the patty cooking apparatus of FIG. 15, taken along line 18-18;

FIG. 19 is a cross-sectional view of the patty cooking apparatus of FIG. 15, taken along line 19-19;

FIG. 20 is an isometric view of the patty cooking apparatus of FIG. 14 with the burger cups removed, showing only the wire rack and the reservoir tray;

FIG. 21 is a top view of the reservoir tray of FIG. 20;

FIG. 22 is a partial front view and partial cross-sectional of the reservoir tray of FIG. 21, view along line 22-22;

FIG. 23 is a side view of the reservoir tray of FIG. 20;

FIG. 24 is a top view of the wire rack of FIG. 20;

FIG. 25 is a front view of the wire rack of FIG. 20;

FIG. 26 is a side view of the wire rack of FIG. 20;

FIG. 27 is a top view of the burger cup of FIG. 14;

FIG. 28 is a right side view of the burger cup of FIG. 27;

FIG. 29 is a front view of the burger cup of FIG. 27;

FIG. 30 is a cross-sectional view of the burger cup of FIG. 27 taken along line 30-30;

FIG. 31 is a cross-sectional view of the burger cup of FIG. 27 taken along line 31-31;

FIG. 32 is a top view of a fifth embodiment of a patty cooking apparatus in accordance with one or more aspects of the present invention;

FIG. 33 is a top view of the patty cooking apparatus of FIG. 32 with burger cups removed showing the reservoir tray and wire rack;

FIG. 34 is a front view of the wire rack of FIG. 33;

FIG. 35 is a side view of the wire rack of FIG. 33;

FIG. 36 is a top view of a burger cup for use with the patty cooking apparatus of FIG. 32;

FIG. 37 is a cross-sectional view of the burger cup of FIG. 36 taken along line 37-37;

FIG. 38 is a cross-sectional view of the burger cup of FIG. 36 taken along line 38-38;

FIG. 39 is a right side view of the burger cup of FIG. 36;

FIG. 40 is a front view of the burger cup of FIG. 36;

FIG. 41 is a top view of an alternative burger cup for use with the patty cooking apparatus of FIG. 32;

FIG. 42 is a bottom view of the burger cup of FIG. 41;

FIG. 43 is a front view of the burger cup of FIG. 41; and

FIG. 44 is a right side view of the burger cup of FIG. 41.

### DETAILED DESCRIPTION

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. As should be understood, any embodiment may incorporate only one or a plurality of the above-disclosed aspects of the invention and may further incorporate only one or a plurality of the above-disclosed features. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, one or more preferred embodiments of the present invention are next described. The following description of one or more preferred embodiments is merely exemplary in nature and is in no way intended to limit the invention, its implementations, or uses.

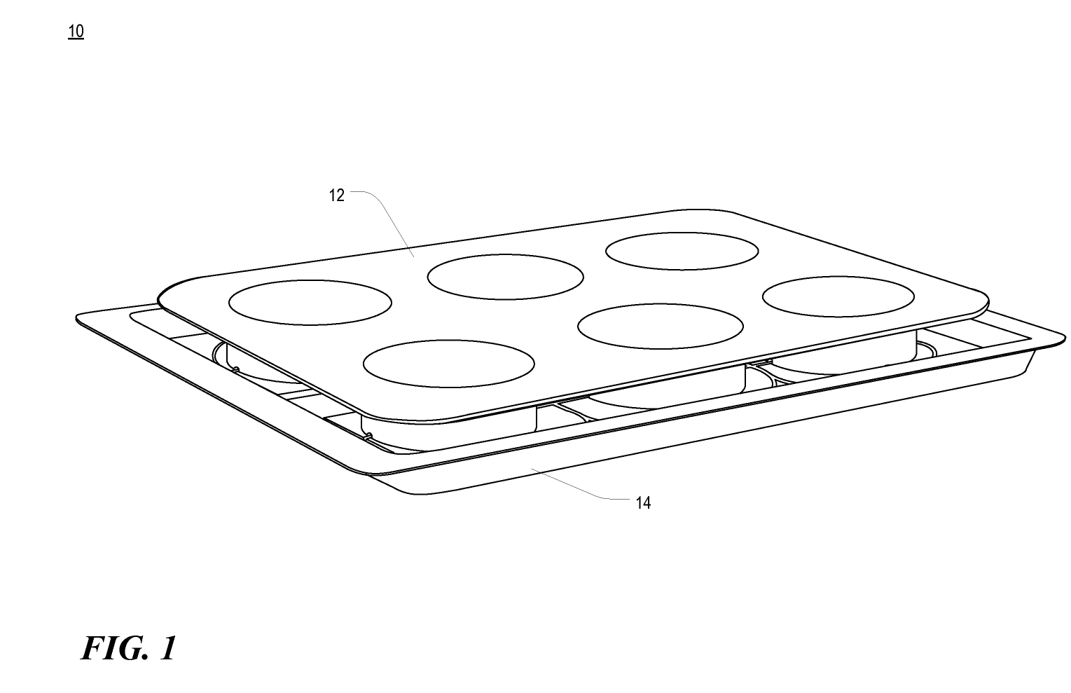

FIG. 1 is a perspective view of a first embodiment of a patty cooking apparatus 10 in accordance with one or more aspects of the present invention. As illustrated, a patty cooking apparatus 10 is comprised of a cupped cooking tray 12 and a reservoir tray 14. As shown in FIG. 1, the cupped cooking tray 12 and the reservoir tray 14 are each configured as separate components that are usable together.

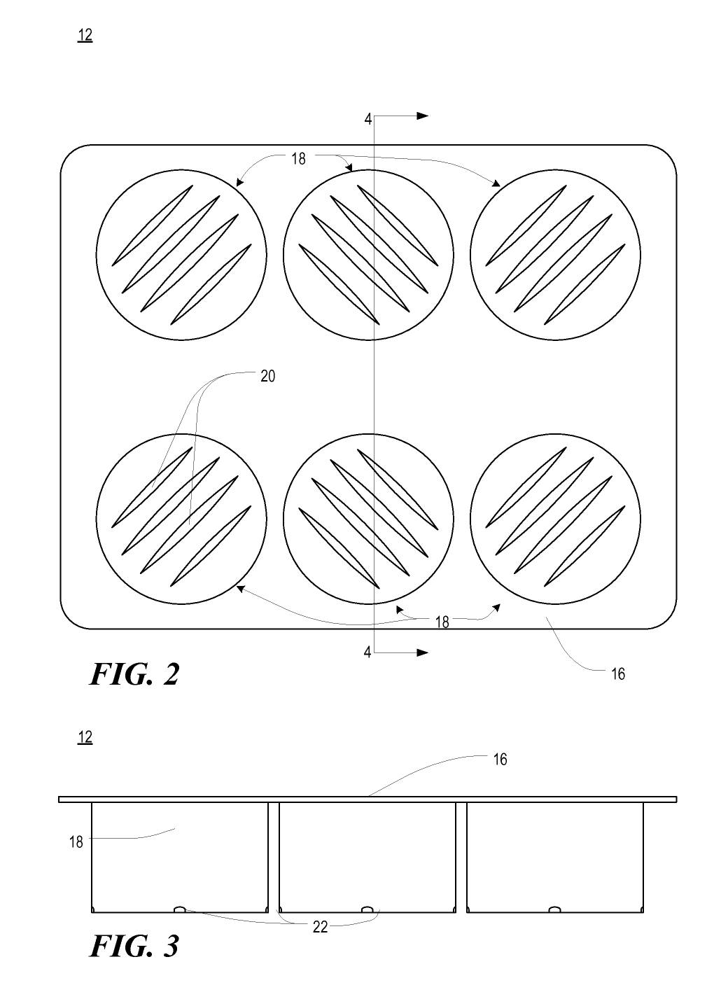

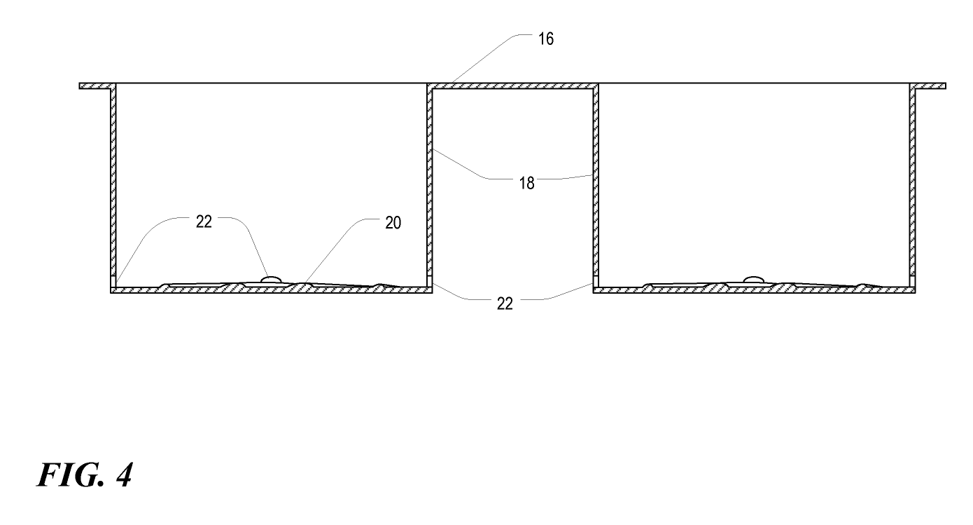

FIGS. 2-4 illustrate the cupped cooking tray 12 in further detail. FIG. 2 is a top view of the cupped cooking tray 12 as shown as part of the patty cooking apparatus of FIG. 1. FIG. 3 is a front view of the cupped cooking tray 12 of FIG. 2, and FIG. 4 is a cross-sectional view of the cupped cooking tray 12 of FIG. 2, taken along line 4-4. The cupped cooking tray 12 is comprised of one or more oven-safe, heat-resistant materials, such as cast iron, steel, or aluminum. In at least one contemplated embodiment, the cupped cooking tray 12 is comprised of a non-stick material.

The cupped cooking tray 12 has a generally flat top surface 16 interrupted by a plurality of cups 18. Each cup 18 is generally cylindrical in shape with an open top, a closed bottom, and a singular curved side that connects the bottom of the cup 18 to the top surface 16. In at least one contemplated embodiment, each cup 18 has a height of about 4-inches and a diameter of about 2.5-inches. Each cup 18 is configured to retain a quantity of meat in the shape of a generally circular patty. The top of each cup 18 is open, and the upper limit of each cup 18 is marked by the connection with the surface of the tray 16. The bottom of each cup 18 is generally flat, but for one or more protruding grooves 20, which are configured to create indentations on one side of the quantity of meat during the cooking process in order to resemble grill marks. In one contemplated embodiment, illustrated in FIGS. 1-4, four protruding grooves 20 are situated at the bottom of each cup 18. During the cooking process, fat and grease can be collected in between the protruding grooves 20 before exiting the cup 18, as will be explained in greater detail below.

Furthermore, in one contemplated embodiment, the bottom portions of each cup 18 are generally co-planar with one another and are generally parallel to a plane defined by the top surface 16. In another contemplated embodiment, either the bottom portions of each cup 18 or the cups 18 themselves are situated at a slight, acute angle relative to a surface upon which the patty cooking apparatus 10 rests so as to enhance removal of fat and grease during the cooking process.

Each cup 18 includes a filtering system configured to draw away excess fat and grease from the quantity of meat during the cooking process. In at least one contemplated embodiment, the filtering system is comprised of a plurality of slits 22 situated at or near the bottom edge of the side of each cup 18. The slits 22 are sufficiently large so as to permit fat and grease to escape from the cup 18, but are small enough to prevent the quantity of meat from spilling through. Slits 22 may be arranged in any quantity or arrangement. In one contemplated embodiment, four slits 22 are arranged generally evenly about the bottom edge of the side of each cup 18.

In other contemplated embodiments, the filtering system may include mesh, pores, holes, screens, or any other like mechanism that retains solid food while simultaneously allowing liquids, such as fat and grease, to escape.

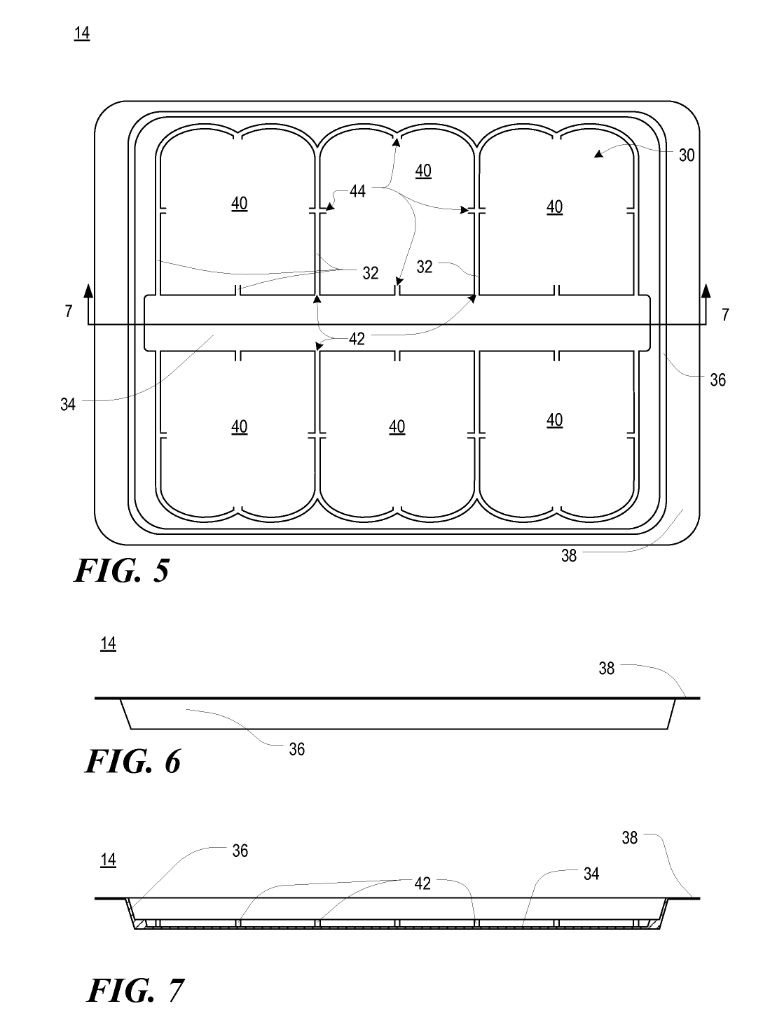

FIGS. 5-7 illustrate the reservoir tray 14. FIG. 5 is a top view of the reservoir tray 14 as shown as part of the patty cooking apparatus 10 of FIG. 1. FIG. 6 is a front view of the reservoir tray 14 of FIG. 5, and FIG. 7 is a cross-sectional view of the reservoir tray 14 of FIG. 5, taken along line 7-7. The reservoir tray 14 includes an inner portion 30 containing a plurality of drainage channels 32 and a receptacle 34. The inner portion 30 has a flat surface with a generally constant elevation that is broken into sections 40 by the presence of the drainage channels 32. Each separate section 40 is configured to support a cup 18 of the cupped cooking tray 12. In one contemplated embodiment, the bottoms of the cups 18 are situated about 0.25-inches above the reservoir tray 14. The reservoir tray 14 further includes a generally vertical side wall 36 that surrounds the perimeter of the inner portion 30 and a generally horizontal lip 38 extending out from the top edge of the generally vertical side wall 36.

The receptacle 34 has a generally flat surface and is positioned at a lower elevation than the remainder of the inner surface 30 of the reservoir tray 14. The receptacle 34 is configured to collect and store excess grease and fat that drains from the cups 18 of the cupped cooking tray 12 through the slits 22 and the drainage channels 32. The receptacle 34 is connected to the drainage channels 32 via a plurality of lower drainage channel openings 42. The drainage channels 32 are arranged in either a straight line or with a gentle curve so as to aid the flow of fat and grease to the receptacle 34. In at least one contemplated embodiment of the reservoir tray 14, the receptacle 34 is generally rectangular in shape and has fourteen lower drainage channel openings 42 leading either to the drainage channels 32 or directly to the receptacle 34.

The drainage channels 32 are configured to approximately align with the slits 22 on the cups 18 of the cupped cooking tray 12, thereby receiving excess fat and grease that drains through the slits 22 and is filtered from the quantity of meat during the cooking process. The drainage channels 32 have a plurality of upper drainage channel openings 44 that are integral with the sections 40 of the reservoir tray 14. In one contemplated embodiment, four upper drainage channel openings 44 are arranged to correspond with four slits 22 evenly spaced about the bottom edge of each cup 18. The drainage channels 32 also have a plurality of lower drainage channel openings 42 that are integral with the receptacle 34. The upper drainage channel openings 44 have an elevation that is relatively even with the sections 40 and align with the slits 22 on the cups 18 so that as fat and grease drains from the slits 22, the fat and grease enters the drainage channels 32 through the upper drainage channel openings 44. The lower drainage channel openings 42 have an elevation that is relatively even with the receptacle 34. The drainage channels 32 gradually decrease in elevation from the upper openings 44 toward the lower openings 42. With the receptacle 34 being positioned at a lower elevation than the remainder of the inner surface 30 of the reservoir tray 14, the drainage channels 32 guide the fat and grease from the cups 18 to the receptacle 34 by the effect of gravity.

The generally vertical side wall 36 surrounding the inner portion 30 creates a barrier that prevents liquids on the inner portion 30 from flowing off the reservoir tray 14. The generally horizontal lip 38 extending out from the top edge of the generally vertical side wall 36 provides a generally flat surface that a user can grab to move the reservoir tray 14, such as when inserting or removing the patty cooking apparatus 10 from an oven.

Operation of the patty cooking apparatus 10 can now be understood. Quantities of meat can be placed in each of the cups 18 of the cupped cooking tray 12. The meat can be formed into the shape of patties within each cup 18. The cupped cooking tray 12 can then be placed on top of the reservoir tray 14, with each cup 18 generally aligned with a corresponding section 40 of the reservoir tray 14. The patty cooking apparatus 10 can then be placed into a conventional baking oven or other desired cooking device. During the cooking process, excess fat and grease can be drained and filtered from each cup 18. The excess fat and grease exits the cups 18 via the slits 20 and follows the drainage channels 32 downwardly to the receptacle 34, where the excess fat and grease is collected. Once the cooking process is complete, the patty cooking apparatus 10 can be removed from the baking oven or other cooking device and the cooked patty is ready for consumption.

The patty cooking apparatus 10 may be used in connection with a wide variety of meats, including beef and poultry. Other ingredients, such as vegetables, cheese, or olives, may be included in the cups 18 with the meat during the cooking process in order to add flavor or complement the meal. The meat patties may be sized for placement on a bun for preparation as a hamburger or other sandwich.

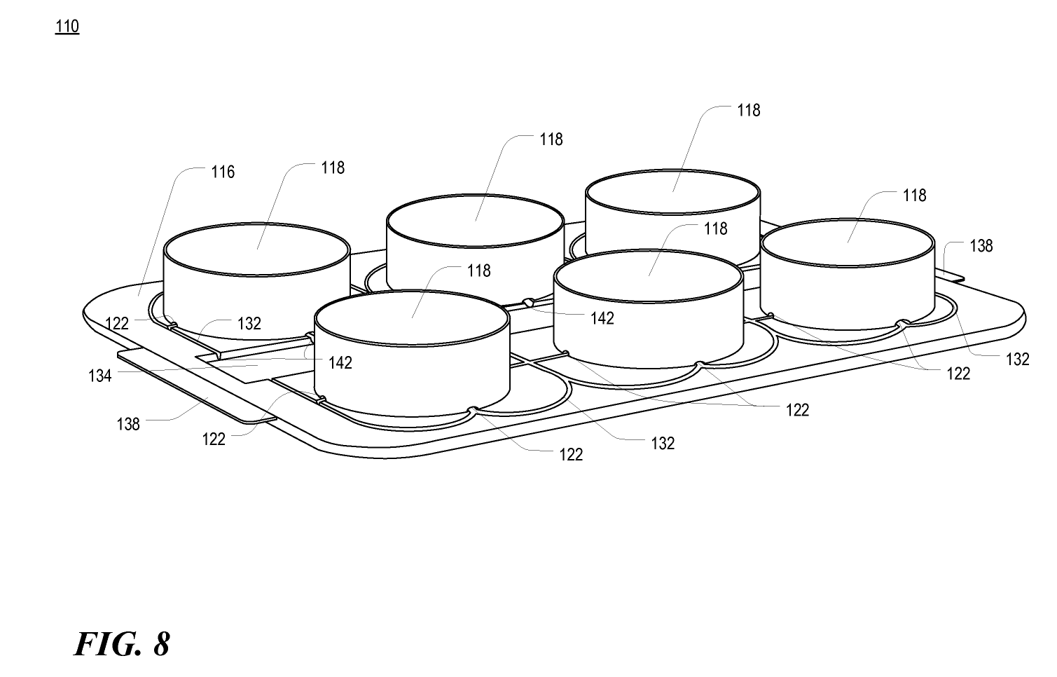

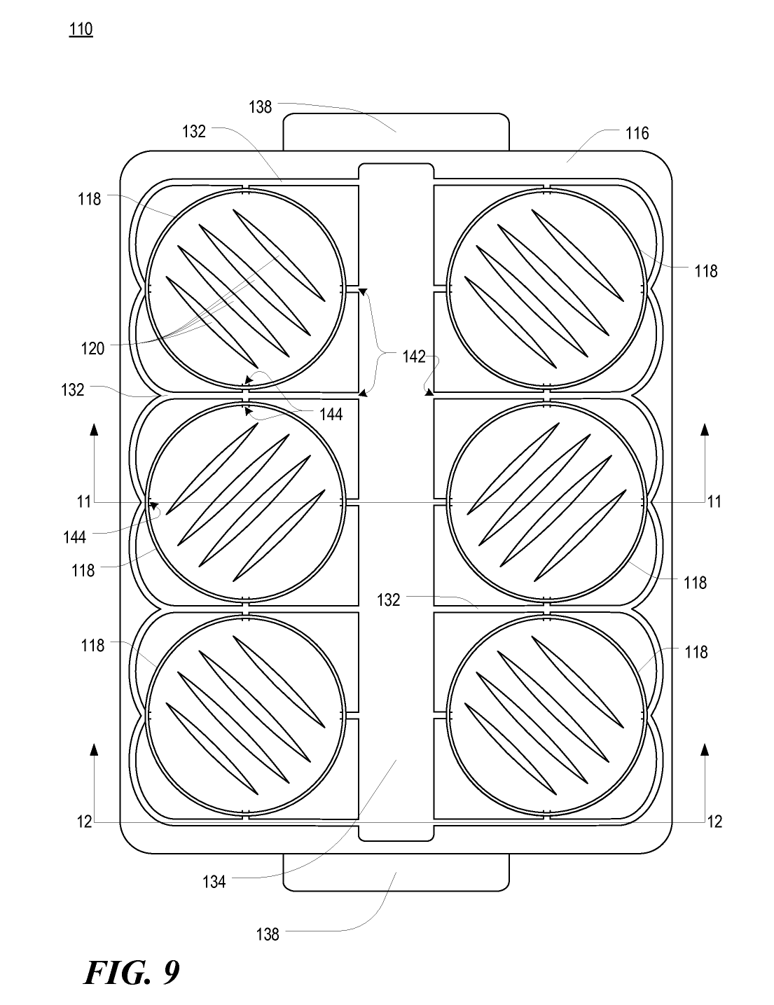

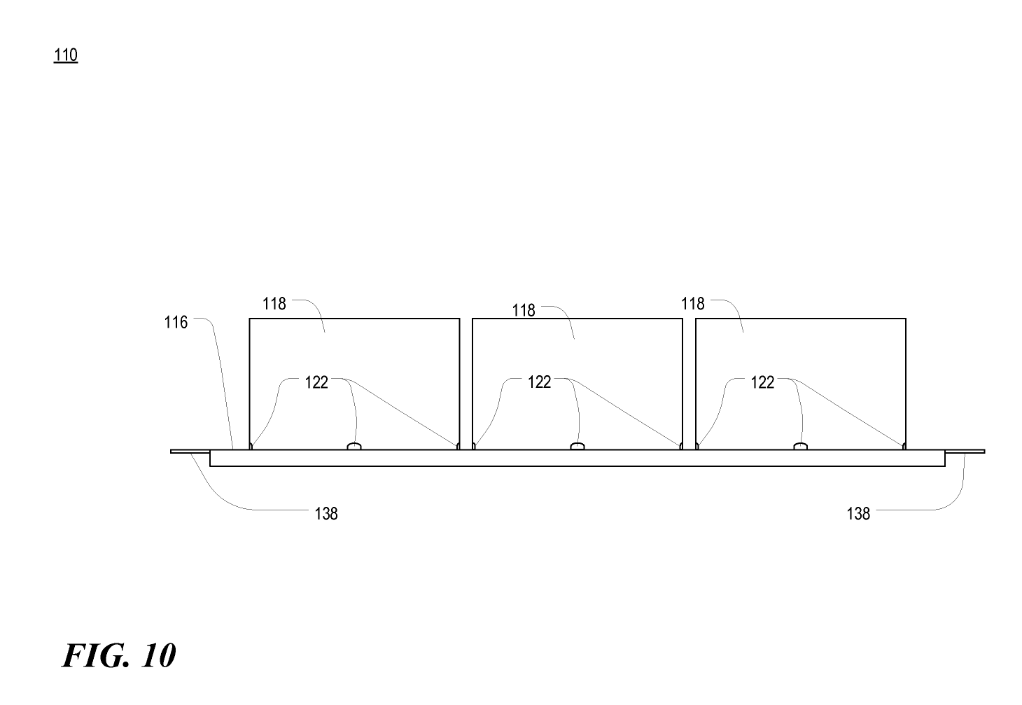

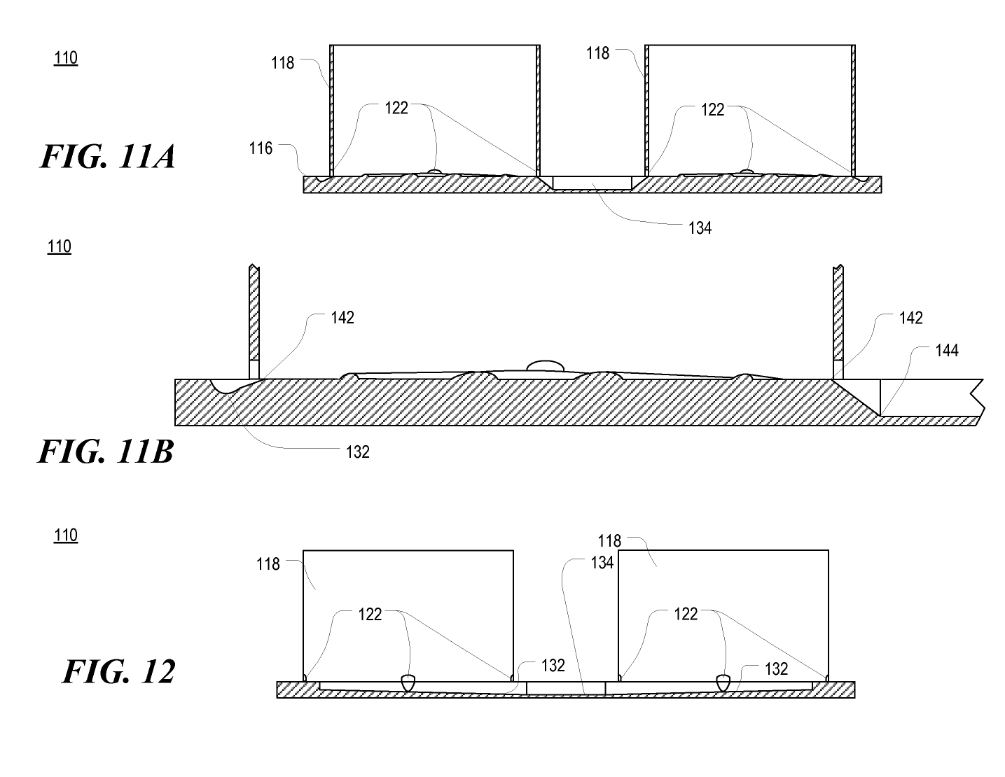

FIG. 8 is a perspective view of a second embodiment of a patty cooking apparatus 110 in accordance with one or more aspects of the present invention. FIGS. 9-12 illustrate the patty cooking apparatus 110 in further detail. FIG. 9 is a top view of the patty cooking apparatus 110 of FIG. 8, and FIG. 10 is a front view of the patty cooking apparatus 110 of FIG. 8. FIG. 11A is a cross-sectional view of the patty cooking apparatus 110 of FIG. 9, taken along line 11-11, and FIG. 11B is an enlarged view of a portion of FIG. 11A. FIG. 12 is a cross-sectional view of the patty cooking apparatus 110 of FIG. 9, taken along line 12-12. As illustrated in FIGS. 8-12, the patty cooking apparatus 110 is comprised of one or more oven-safe, heat-resistant materials, such as cast iron, steel, or aluminum. In at least one contemplated embodiment, the patty cooking apparatus 110 is comprised of a non-stick material. Furthermore, the patty cooking apparatus 110 has a generally flat surface 116 interrupted by a plurality of cups 118 protruding therefrom. Additionally, the patty cooking apparatus 110 may be constructed as a unitary structure.

Each cup 118 is generally cylindrical in shape with an open top, a closed bottom, and a singular curved side that comprises the height which the cup 118 extends from the surface 116. In at least one preferred embodiment 110 the cup 118 has a height of about 4-inches and a diameter of about 2.5-inches. Each cup 118 is configured to retain a quantity of meat in the shape of a circular patty. The bottom of each cup 118 is the portion of the surface 116 that is enclosed by the connection of the curved side of the cup 118 with the surface 116. The bottom of each cup 118 is generally flat but for one or more protruding grooves 120, which are configured to create indentations on one side of the quantity of meat during the cooking process in order to resemble grill marks. In one contemplated embodiment, four protruding grooves 120 are situated at the bottom of each cup 118. During the cooking process, fat and grease can be collected in between the protruding grooves 120 before exiting the cup 118, as will be explained in greater detail below.

Furthermore, in one contemplated embodiment, the bottom portions of each cup 118 are generally co-planar with one another and are generally parallel to a plane defined by the top surface 116. In another contemplated embodiment, either the bottom portions of each cup 118 or the cups 118 themselves are situated at a slight, acute angle relative to a surface upon which the patty cooking apparatus 110 rests so as to enhance removal of fat and grease during the cooking process.

Each cup 118 includes a filtering system configured to draw away excess fat and grease from the quantity of meat during the cooking process. In at least one contemplated embodiment, the filtering system is comprised of a plurality of slits 122 situated at or near the bottom edge of the side of each cup 118. The slits 122 are sufficiently large so as to permit fat and grease to escape from the cup 118, but are small enough to prevent the quantity of meat from spilling through. Slits 122 may be arranged in any quantity or arrangement. In one contemplated embodiment, four slits 122 are arranged generally evenly about the bottom edge of the side of each cup 118.

In other contemplated embodiments, the filtering system may comprise mesh, pores, holes, screens, or any other like mechanism that retains solid food while simultaneously allowing liquids, such as fat and grease, to escape.

FIGS. 8-12 further illustrate other components of a patty cooking apparatus 110, including a plurality of drainage channels 132 that extend along the surface 116 of the patty cooking apparatus 110, a receptacle 134, and handles 138. The handles 138, which extend outwardly from the surface 116, provide a means for a user to grab and move the patty cooking apparatus 110, such as when inserting or removing the patty cooking apparatus 10 from an oven.

The receptacle 134 has a generally flat surface and is at a lower elevation than the remainder of the surface 116. The receptacle 134 is configured to collect and store excess grease and fat that drains from the cups 118 through the slits 122 and the drainage channels 132. The receptacle 134 is connected to the drainage channels 132 via a plurality of lower drainage channel openings 142. The drainage channels 132 are arranged in either a straight line or with a gentle curve so as to aid the flow of fat and grease to the receptacle 134. In at least one contemplated embodiment of the patty cooking apparatus 110, the receptacle 134 is generally rectangular in shape and has fourteen lower drainage channel openings 142 leading either to the drainage channels 132 or directly to the receptacle 134.

The drainage channels 132 align with the slits 122 on the cups 118 and are configured to receive excess fat and grease draining from the slits 122 and transport the fat and grease to the receptacle 134. The drainage channels 132 have a plurality of upper drainage channel openings 144 that align with the slits 122 on the cups 118, each slit 122 having one such opening 144. In one contemplated embodiment, four upper drainage channel openings 144 correspond with four slits 122 evenly spaced about the bottom edge of each cup 118. The drainage channels 132 also have a plurality of lower drainage channel openings 142 that are integral with the receptacle 134. The upper drainage channel openings 142 have an elevation that is relatively even with the surface 116 and align with the slits 122 on the cups 118 so that as fat and grease drains from the slits 122, the fat and grease enters the drainage channels 132 through the upper drainage channel openings 144. The lower drainage channel openings 142 have an elevation that is relatively even with the receptacle 134. The drainage channels 132 gradually decrease in elevation from the upper openings 144 toward the lower openings 142. With the receptacle 134 being positioned at a lower elevation than the remainder of the surface 116, the drainage channels 132 guide the fat and grease from the cups 118 to the receptacle 134 by the effect of gravity. In one contemplated embodiment, the bottoms of the cups 18 are situated about 0.25-inches above the receptacle 134.

Operation of the patty cooking apparatus 110 can now be understood. Quantities of meat can be placed in each of the cups 118 of the patty cooking apparatus 110. The meat can be formed into the shape of patties within each cup 118. The patty cooking apparatus 110 can then be placed into a conventional baking oven or other desired cooking device. During the cooking process, excess fat and grease can be drained and filtered from each cup 118. The excess fat and grease exits the cups 118 via the slits 120 and follows the drainage channels 132 downwardly to the receptacle 134, where the excess fat and grease is collected. Once the cooking process is complete, the patty cooking apparatus 110 can be removed from the baking oven or other cooking device and the cooked patty is ready for consumption.

The patty cooking apparatus 110 may be used in connection with a wide variety of meats, including beef and poultry. Other ingredients, such as vegetables, cheese, or olives, may be included in the cups 118 with the meat during the cooking process in order to add flavor or complement the meal. The meat patties may be sized for placement on a bun for preparation as a hamburger or other sandwich.

FIG. 13 is a perspective view of a third embodiment of a patty cooking apparatus 210 in accordance with one or more aspects of the present invention. As shown in FIG. 13, the patty cooking apparatus 210 is an alternative embodiment to the patty cooking apparatus 110 depicted in FIGS. 8-12, but with two cups 218. The patty cooking apparatus 210 otherwise functions in a similar manner to the patty cooking apparatus 110 depicted in FIGS. 8-12.

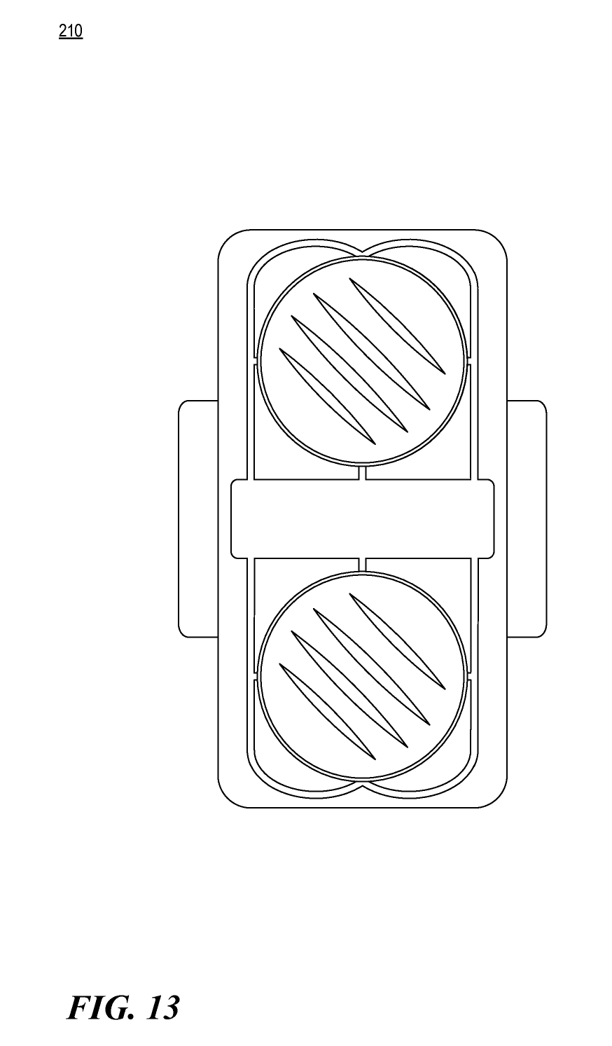

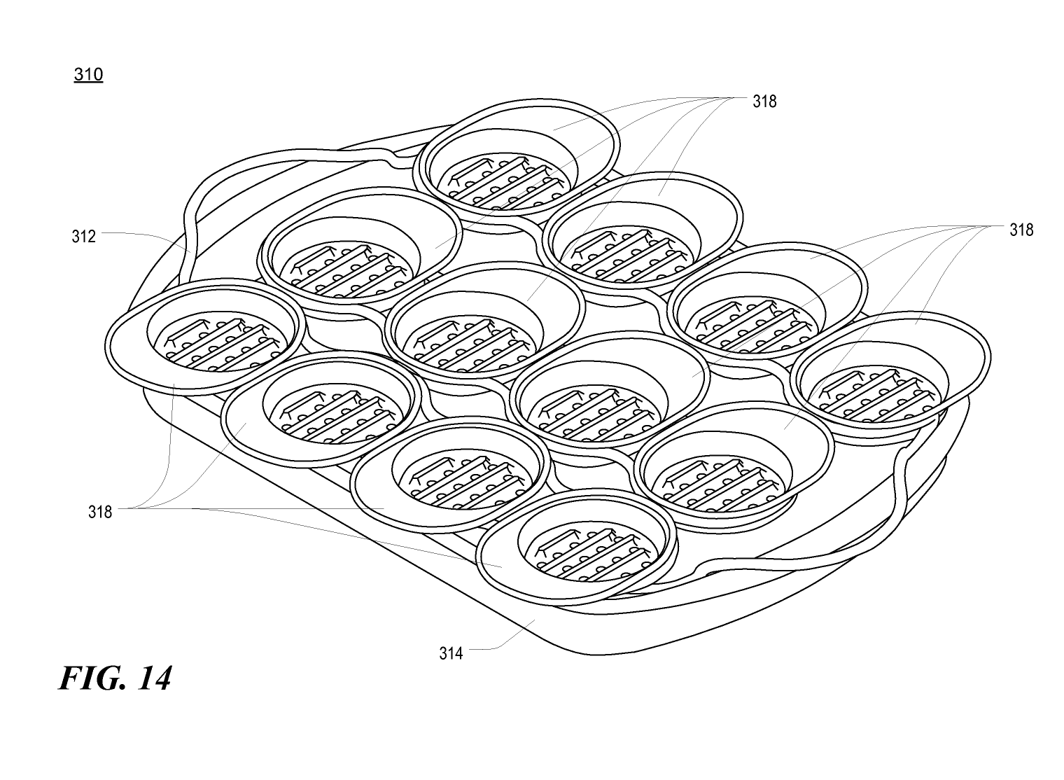

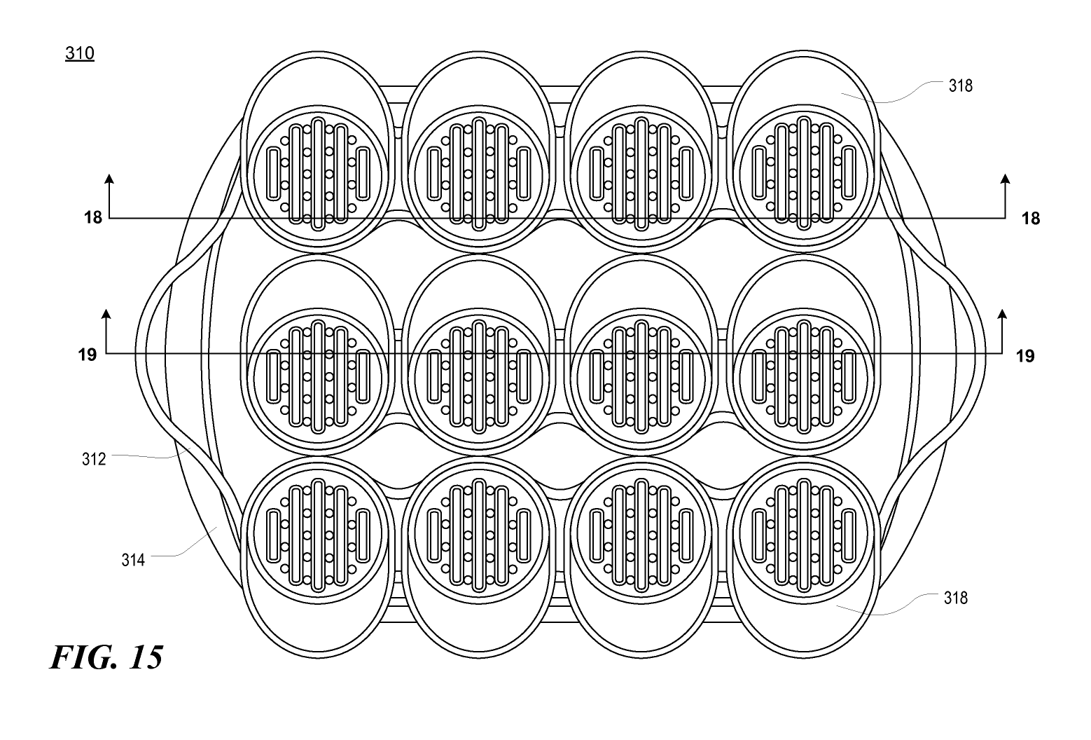

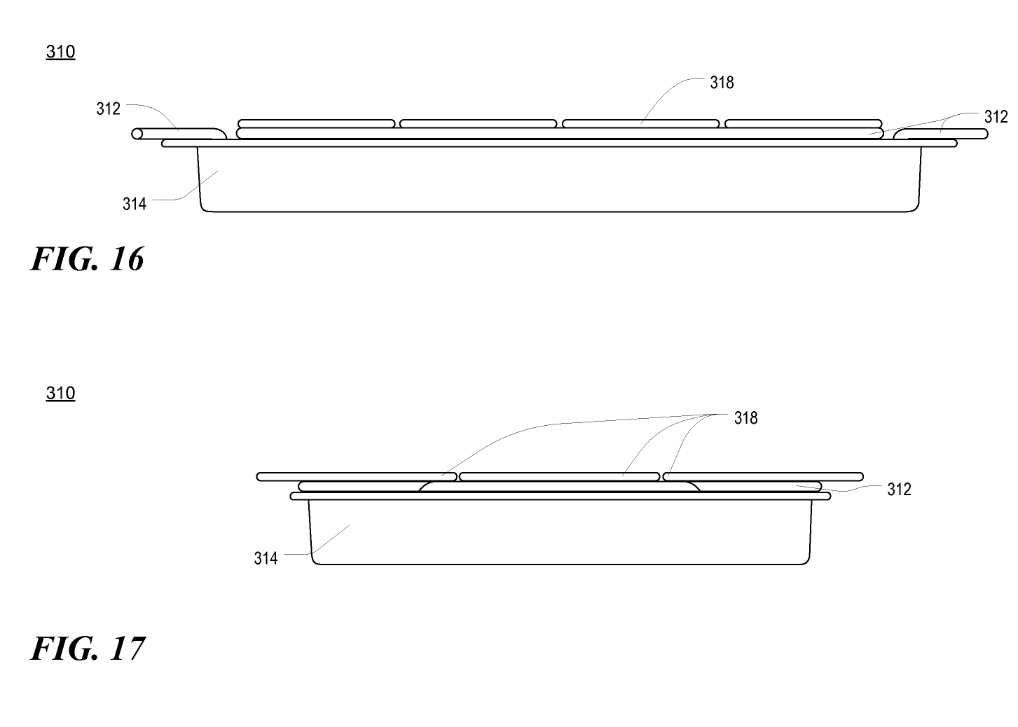

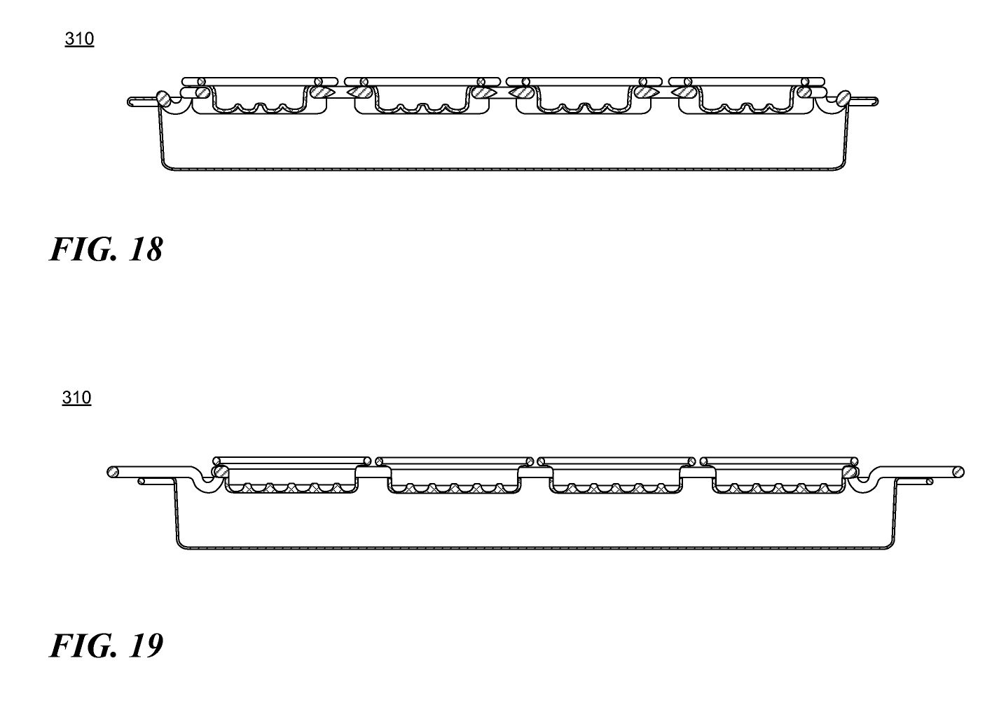

FIG. 14 is an isometric view of a fourth embodiment of a patty cooking apparatus 310, including a plurality of burger cups 318, in accordance with one or more aspects of the present invention. FIGS. 15-31 illustrate the patty cooking apparatus 310 in further detail. FIG. 15 is a top view of the patty cooking apparatus 310 of FIG. 14, and FIGS. 16 and 17 are front and side views, respectively, of the patty cooking apparatus 310 of FIG. 14. FIG. 18 is a cross-sectional view of the patty cooking apparatus 310 of FIG. 15, taken along line 18-18, and FIG. 19 is a cross-sectional view of the patty cooking apparatus 310 of FIG. 15, taken along line 19-19. As shown, the patty cooking apparatus 310 comprises a wire rack 312, a reservoir tray 314, and a plurality of cups 318. As illustrated in FIGS. 14-19, the patty cooking apparatus 310 is comprised of one or more oven-safe, heat-resistant materials, such as cast iron, steel, or aluminum. In at least one contemplated embodiment, the patty cooking apparatus 310 is comprised of a non-stick material.

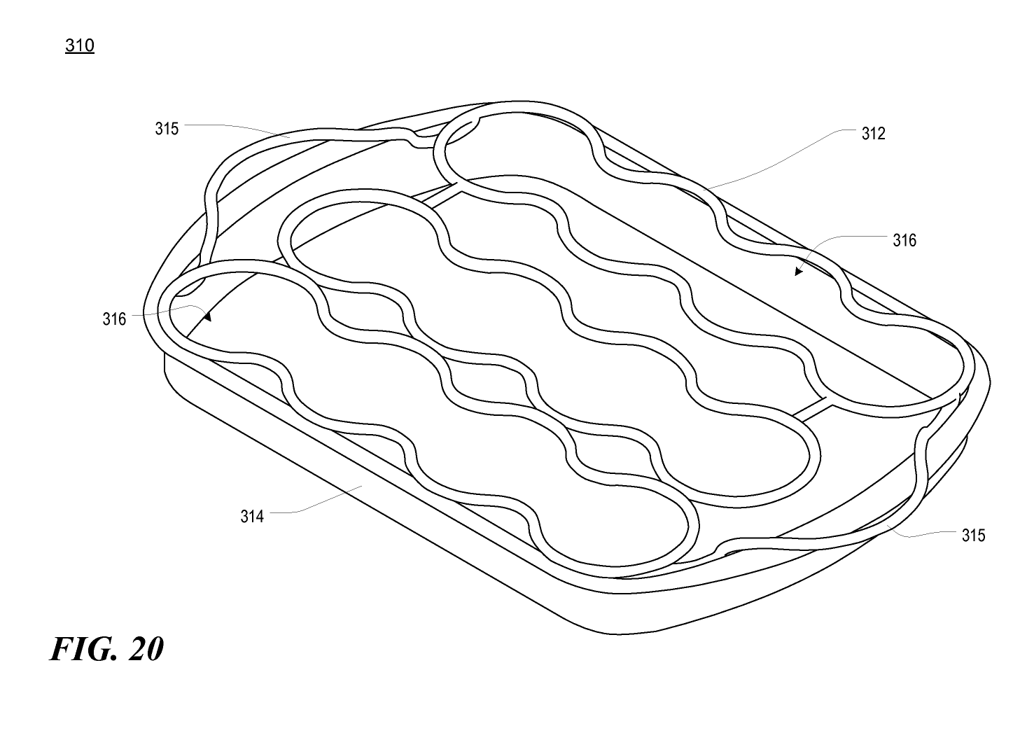

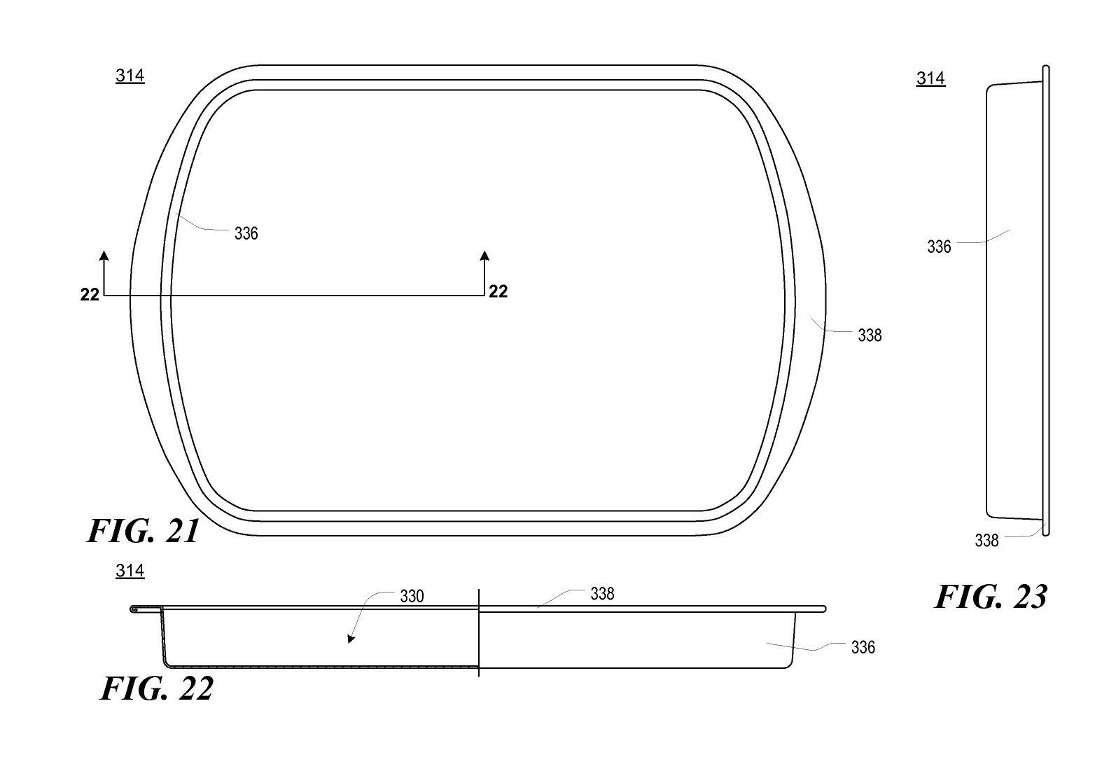

FIG. 20 is an isometric view of the patty cooking apparatus 310 of FIG. 14 with the cups 318 removed, showing only the wire rack 312 and the reservoir tray 314. FIG. 21 is a top view of the reservoir tray 314 of FIG. 20. FIG. 22 is a partial front view and partial cross-sectional view along line 22-22 of the reservoir tray 314 of FIG. 21. FIG. 23 is a side view of the reservoir tray 314 of FIG. 20. The reservoir tray 314 includes an inner portion 330 having a generally flat surface with a constant elevation for collecting excess grease and fat that drains from the cups 318. The reservoir tray 314 further includes a generally vertical side wall 336 that surrounds the perimeter of the inner portion 330 and a generally horizontal lip 338 extending out from the top edge of the generally vertical side wall 336 and defining an opening leading to the inner portion 330. The generally vertical side wall 336 surrounding the inner portion 330 creates a barrier that prevents liquids or other substances within the inner portion 330 from flowing off the reservoir tray 314. The generally horizontal lip 338 extending out from the top edge of the generally vertical side wall 336 provides a surface that a user can grab to move the reservoir tray 314, such as when inserting or removing the patty cooking apparatus 310 from an oven.

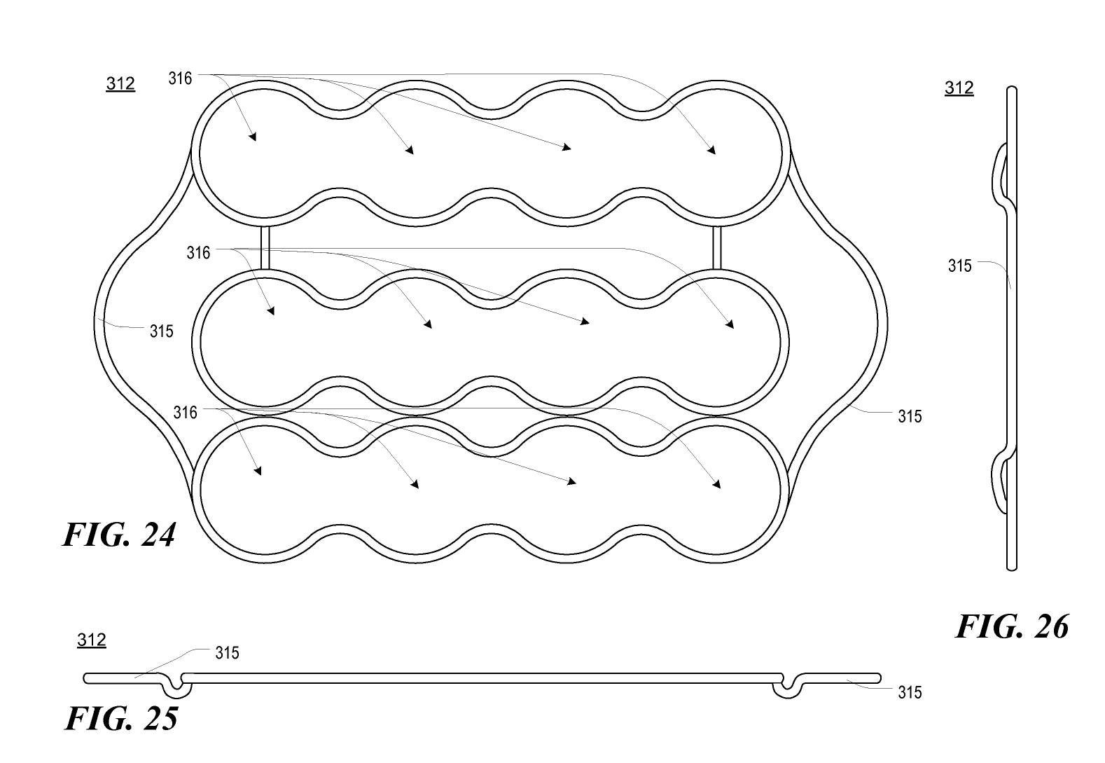

FIG. 24 is a top view of the wire rack 312 of FIG. 20. FIG. 25 is a front view of the wire rack 312 of FIG. 20. FIG. 26 is a side view of the wire rack 312 of FIG. 20. The wire rack 312 defines two handles 315 and a plurality of cup openings 316. In at least one preferred embodiment, the wire rack defines exactly twelve cup openings 316. The wire rack 312 is adapted to rest along the horizontal lip 338 and span the opening to the inner portion 330 of the reservoir tray 314. In at least one embodiment, as clearly seen in FIG. 15, the handles 315 extend beyond the horizontal lips 338. The handles 315 can be used to remove the wire rack 312 along with any cups 318 secured by the cup openings 316 from the reservoir tray 314.

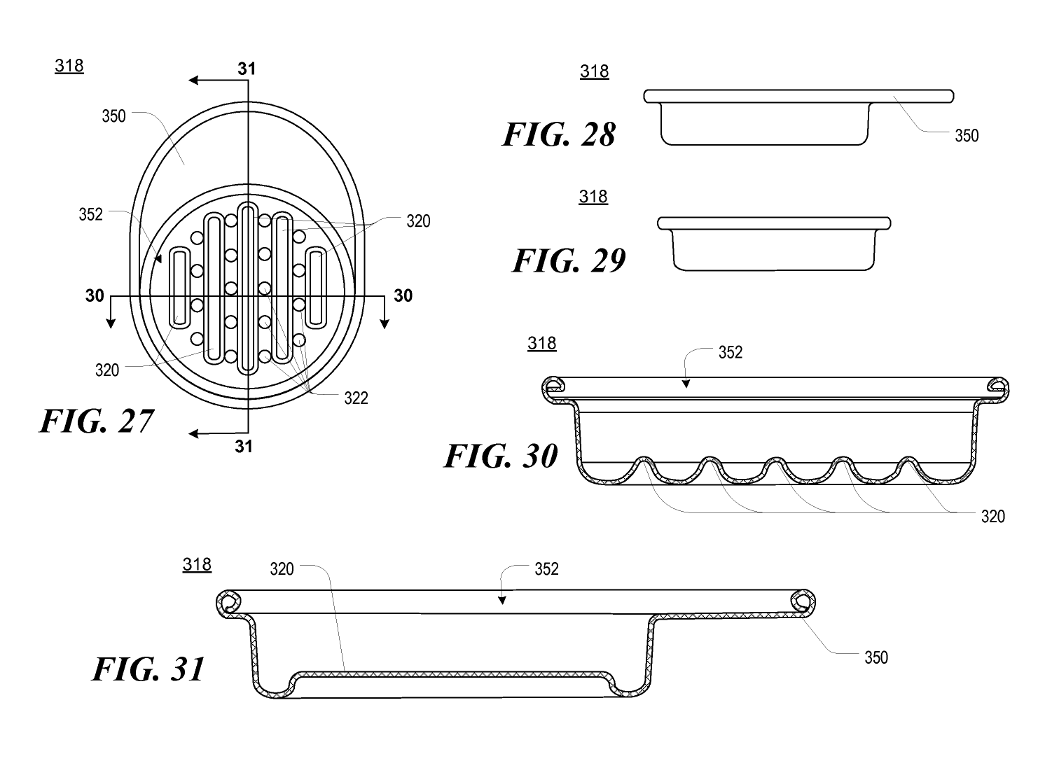

FIGS. 27-31 illustrate a burger cup 318 in accordance with one or more aspects of the present invention. FIG. 27 is a top view of a burger cup 318. FIGS. 28 and 29 are a right side view and a front view, respectively, of the burger cup 318 of FIG. 27. FIGS. 30 and 31 are cross-sectional views of the burger cup 318 of FIG. 27 taken along lines 30-30 and 31-31, respectively.

Each burger cup 318 has an oblong top portion defining a grip 350 that can be used to help place or remove the burger cup 318 from a cup opening 316 in the wire rack 312. Each burger cup 318 further comprises a cylindrical storage cavity 352. In at least one contemplated embodiment, the storage cavity 352 of each burger cup 318 has a depth of approximately two-thirds inch (⅔″) and a diameter of approximately two and one-half inches (2½″). Each storage cavity 352 is configured to retain a quantity of meat or other solid ingredients in the shape of a generally circular patty. The bottom of each storage cavity 352 is generally flat, but for one or more protruding grooves 320 configured to create indentations on one side of the quantity of meat during the cooking process in order to resemble grill marks. The bottom of each storage cavity 352 further includes a plurality of drainage openings 322 allowing for the drainage of excess fat and grease produced during the cooking process. As excess fat and grease flows through the drain openings 322, it is collected in the reservoir tray 314. In one contemplated embodiment, best shown in FIG. 27, five protruding grooves 320 and eighteen small circular drainage openings 322 are situated at the bottom of the storage cavity 352.

Operation of the patty cooking apparatus 310 can now be understood. Quantities of meat or other solid ingredients can be placed in the storage cavities 352 each of the cups 318. The meat can be formed into the shape of patties within each storage cavity 352. The wire rack 312 must be placed atop the reservoir tray 314, and each cup 318 can then be placed into one of the cup openings 316 in the wire rack 312. Alternatively, a cup 318 may be placed into a cup opening 316 prior to being loaded with meat or other solid ingredients. The patty cooking apparatus 310 can then be placed into a conventional baking oven or other desired cooking device. During the cooking process, excess fat and grease can be drained and filtered from each the storage cavity 352 of each cup 318. The excess fat and grease exits the storage cavities 352 via the drainage openings 322 and drips onto the inner portion 330 of the reservoir tray 314 where it is collected. Once the cooking process is complete, the patty cooking apparatus 310 can be removed from the baking oven or other cooking device and the cooked patties therein can be removed and consumed or stored for later consumption.

The patty cooking apparatus 310 may be used in connection with a wide variety of meats, including beef and poultry. Other ingredients, such as vegetables, cheese, or olives, may be included in the cups 318 with the meat during the cooking process in order to add flavor or complement the meal. The meat patties may be sized for placement on a bun for preparation as a hamburger or other sandwich.

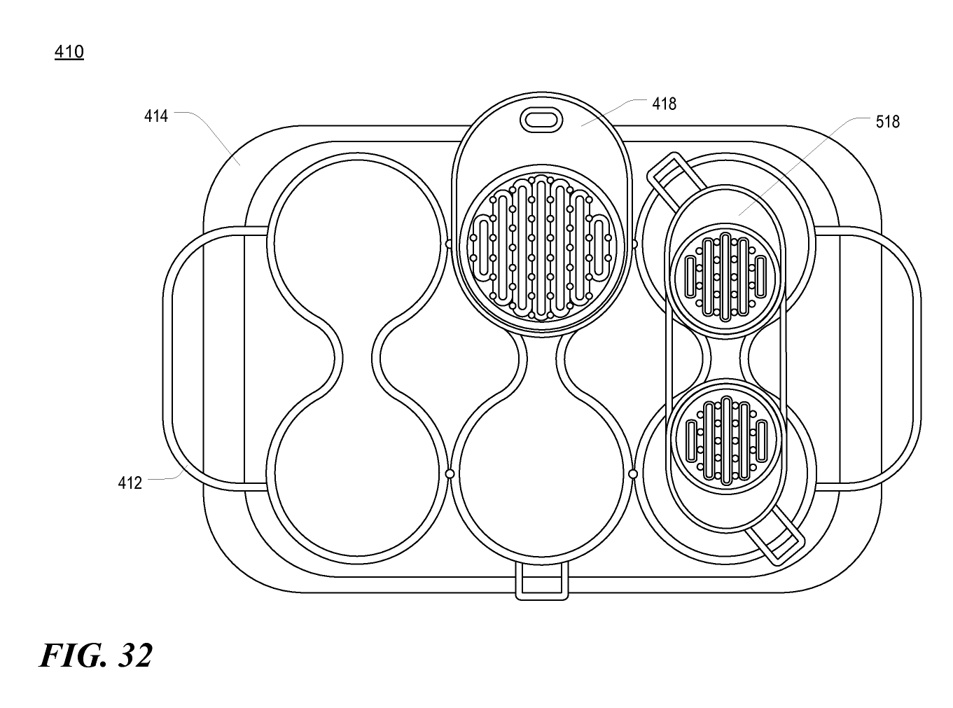

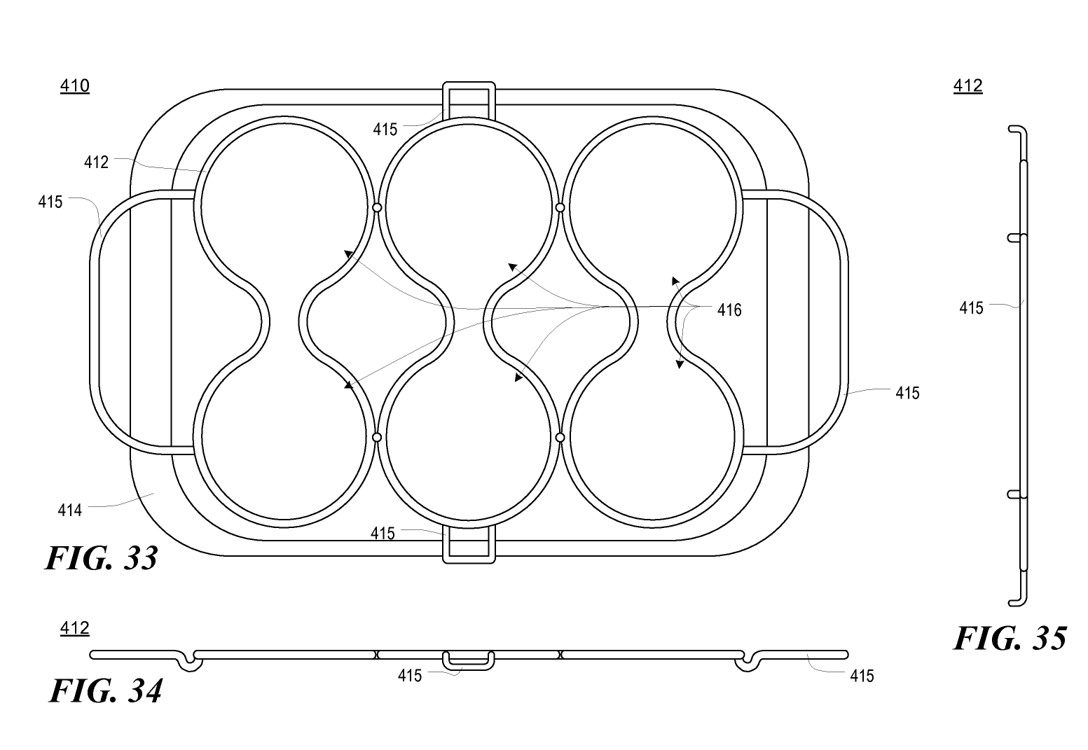

FIG. 32 is a top view of a fifth embodiment of a patty cooking apparatus 410 in accordance with one or more aspects of the present invention. FIGS. 33-44 illustrate the patty cooking apparatus 410 in further detail. As shown, the patty cooking apparatus 410 comprises a wire rack 412, a reservoir tray 414, and a plurality of cups 418,518. As illustrated in FIG. 32, the patty cooking apparatus 410 is comprised of one or more oven-safe, heat-resistant materials, such as cast iron, steel, or aluminum. In at least one contemplated embodiment, the patty cooking apparatus 410 is comprised of a non-stick material.

FIG. 33 is a top view of the patty cooking apparatus 410 of FIG. 32 with burger cups 418,518 removed showing the reservoir tray 414 and wire rack 412. FIGS. 34 and 35 are front and side views, respectively, of the wire rack 412 of FIG. 33.

The reservoir tray 414 is similar to the reservoir tray 314 in that the reservoir tray 414 includes an inner portion having a generally flat surface with a constant elevation for collecting excess grease and fat that drains from the cups 418,518. The reservoir tray 414 further includes a generally vertical side wall surrounding the perimeter of the inner portion and a generally horizontal lip extending out from the top edge of the generally vertical side wall and defining an opening leading to the inner portion. The generally vertical side wall surrounding the inner portion creates a barrier that prevents liquids or other substances within the inner portion from flowing off the reservoir tray 414. The generally horizontal lip extending out from the top edge of the generally vertical side wall provides a surface that a user can grab to move the reservoir tray 414, such as when inserting or removing the patty cooking apparatus 410 from an oven.

The wire rack 412 defines four handles 415 and a plurality of cup openings 416. In at least one preferred embodiment, the wire rack defines exactly six cup openings 416. The wire rack 412 is adapted to rest along the horizontal lip of the reservoir tray 414 and span the opening to the inner portion of the reservoir tray 414. In at least one embodiment, as clearly seen in FIG. 33, the handles 415 extend beyond the horizontal lips of the reservoir tray 414. The handles 415 can be used to remove the wire rack 412 along with any cups 418,518 secured by the cup openings 416 from the reservoir tray 414.

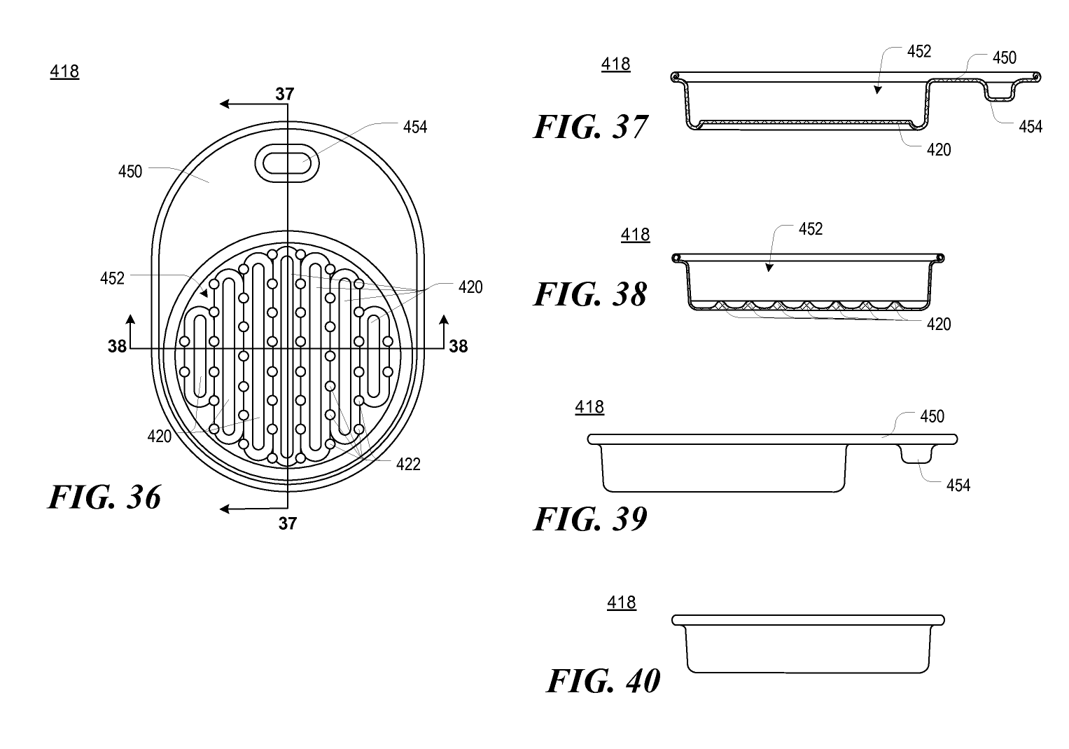

FIGS. 36-40 illustrate a burger cup 418 for use with the patty cooking apparatus 410 in accordance with one or more aspects of the present invention. FIG. 36 is a top view of a burger cup 418. FIGS. 37 and 38 are cross-sectional views of the burger cup 418 of FIG. 36 taken along lines 37-37 and 38-38, respectively. FIGS. 39 and 40 are a right side view and a front view, respectively, of the burger cup 418 of FIG. 36.

Each burger cup 418 has an oblong top portion defining a grip 450 that can be used to help place or remove the burger cup 418 from a cup opening 416 in the wire rack 412. The grip 450 includes a downwardly-extending protrusion 454 positioned to prevent the burger cup 418 from sliding. In at least one embodiment, the protrusion 454 has a depth of approximately three-eighth inch (⅜″). Each burger cup 418 further comprises a cylindrical storage cavity 452. In at least one contemplated embodiment, the storage cavity 452 of each burger cup 418 has a depth of approximately one-inch (1″) and a diameter of approximately four-inches (4″). Each storage cavity 452 is configured to retain a quantity of meat or other solid ingredients in the shape of a generally circular patty. The bottom of each storage cavity 452 is generally flat, but for one or more protruding grooves 420 configured to create indentations on one side of the quantity of meat during the cooking process in order to resemble grill marks. The bottom of each storage cavity 452 further includes a plurality of drainage openings 422 allowing for the drainage of excess fat and grease produced during the cooking process. As excess fat and grease flows through the drain openings 422, it is collected in the reservoir tray 414. In one contemplated embodiment, best shown in FIG. 36, seven protruding grooves 420 and forty-six small circular drainage openings 422 are situated at the bottom of the storage cavity 452.

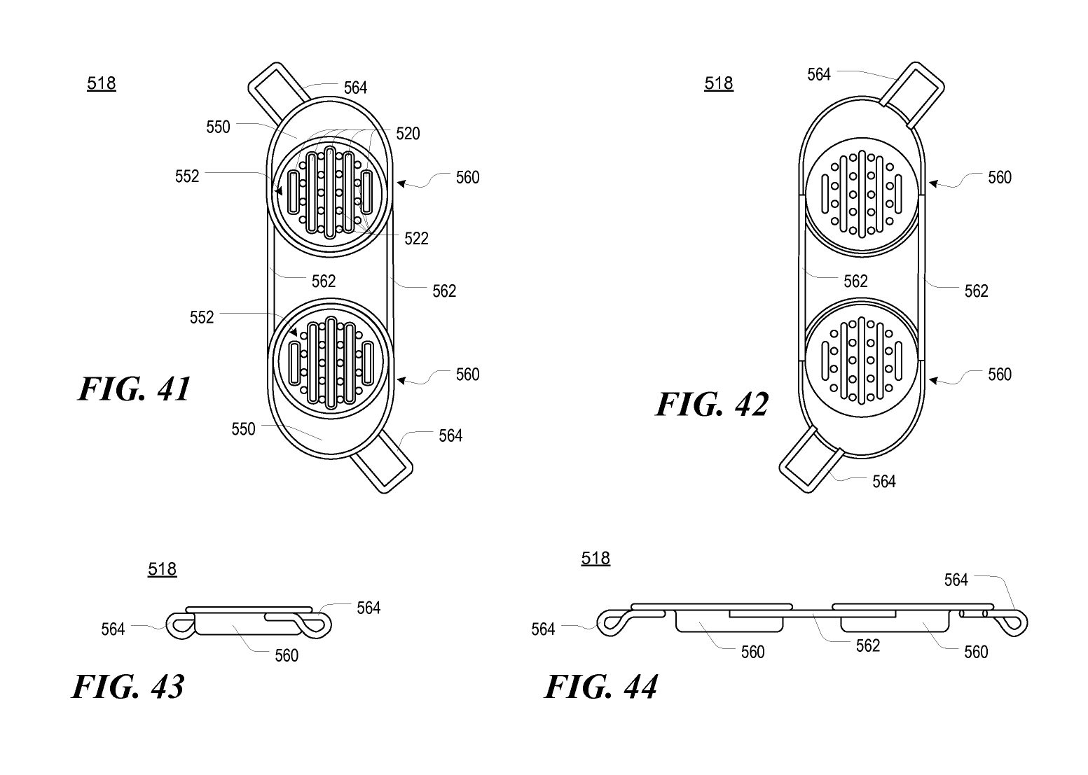

FIGS. 41-44 illustrate a burger cup 518 for use with the patty cooking apparatus 410 in accordance with one or more aspects of the present invention. FIG. 41 is a top view of a burger cup 518, and FIG. 42 is a bottom view of the burger cup 518 of FIG. 41. FIGS. 43 and 44 are a front view and a right side view, respectively, of the burger cup 518 of FIG. 41.

Each burger cup 518 is an assembly comprising two attached cup portions 560, wire connectors 562 used to secure the cup portions 560 to one another, and wire handles 564 to aid in handling the burger cup 518 and to prevent the burger cup 518 from sliding when placed in a cup opening 416. Each cup portion 560 includes an oblong top portion defining a grip 550 that can be used to help place or remove the burger cup 518 from a cup opening 416 in the wire rack 412. Each cup portion 560 further comprises a cylindrical storage cavity 552. In at least one contemplated embodiment, the storage cavity 552 of each cup portion 560 of the burger cup 518 has a depth of approximately two-thirds inch (⅔″) and a diameter of approximately two and one-half inches (2½″). Each storage cavity 552 is configured to retain a quantity of meat or other solid ingredients in the shape of a generally circular patty. The bottom of each storage cavity 552 is generally flat, but for one or more protruding grooves 520 configured to create indentations on one side of the quantity of meat during the cooking process in order to resemble grill marks. The bottom of each storage cavity 552 further includes a plurality of drainage openings 522 allowing for the drainage of excess fat and grease produced during the cooking process. As excess fat and grease flows through the drain openings 522, it is collected in the reservoir tray 414. In one contemplated embodiment, best shown in FIG. 41, the bottom of each storage cavity 552 includes five protruding grooves 420 and eighteen small circular drainage openings 422.

Operation of the patty cooking apparatus 410 can now be understood. Quantities of meat or other solid ingredients can be placed in the storage cavities 452,552 of each of the burger cups 418,518. The meat can be formed into the shape of patties within each storage cavity 452,552. The wire rack 412 must be placed atop the reservoir tray 414, and each cup 418,518 placed into one or more of the cup openings 416 in the wire rack 412. It will be appreciated that each burger cup 418 will occupy one cup opening 416 and that each burger cup 518 will occupy two adjacent cup openings 416, with one cup portion 560 per cup opening 416. Alternatively, a burger cup 418,518 may be placed into the one or more cup openings 416 prior to being loaded with meat or other solid ingredients. The patty cooking apparatus 410 can then be placed into a conventional baking oven or other desired cooking device. During the cooking process, excess fat and grease can be drained and filtered from each the storage cavity 452,552 of each cup 418,518. The excess fat and grease exits the storage cavities 452,552 via the drainage openings 422,522 and drips onto the inner portion of the reservoir tray 414 where it is collected. Once the cooking process is complete, the patty cooking apparatus 410 can be removed from the baking oven or other cooking device and the cooked patties therein can be removed and consumed or stored for later consumption.

The patty cooking apparatus 410 may be used in connection with a wide variety of meats, including beef and poultry. Other ingredients, such as vegetables, cheese, or olives, may be included in the burger cups 418,518 with the meat during the cooking process in order to add flavor or complement the meal. The meat patties may be sized for placement on a bun for preparation as a hamburger or other sandwich.

Based on the foregoing description, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention. Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof.

1-18. (canceled)

19. An apparatus for cooking a meat patty comprising:
a. a cooking tray having one or more cups, each sized for holding a quantity of meat; and
b. a reservoir tray configured to support the cooking tray during cooking;
c. wherein the reservoir tray has one or more drainage channels to carry excess fat and grease away from the one or more cups and to a receptacle.

20. The apparatus of claim 19, wherein the cooking tray has at least six cups.

21. The apparatus of claim 19, wherein each of the one or more cups has a generally cylindrical shape.

22. The apparatus of claim 19, wherein each cup has one or more protruding grooves situated at the bottom thereof.

23. The apparatus of claim 22, wherein each cup has at least four protruding grooves.

24. The apparatus of claim 19, wherein the excess fat and grease escapes from the one or more cups via slits situated at or near the bottom of a side thereof.

25. The apparatus of claim 24, wherein each cup has four slits spaced generally evenly.

26. The apparatus of claim 25, wherein the four slits of each cup are aligned with drainage channels of the reservoir tray.

27. The apparatus of claim 19, wherein the drainage channels gradually decrease in elevation toward the receptacle.

28. The apparatus of claim 19, wherein either or both of the cooking tray and the reservoir tray includes a non-stick material.

29. The apparatus of claim 19, wherein the apparatus is usable in a baking oven.

30. An apparatus for cooking a meat patty comprising:
a. one or more cups situated on a cooking surface, each sized for holding a quantity of meat;
b. a receptacle configured to receive excess fat and grease during cooking; and
c. a plurality of drainage channels configured to carry the excess fat and grease from the one or more cups to the receptacle.

31. The apparatus of claim 30, wherein the apparatus is a unitary structure.

32. The apparatus of claim 30, wherein the apparatus has at least two cups.

33-34. (canceled)

35. The apparatus of claim 30, wherein each cup has one or more protruding grooves situated at the bottom thereof.

36. (canceled)

37. The apparatus of claim 30, wherein the excess fat and grease escapes from the one or more cups via slits situated at or near the bottom of a side thereof.

38. The apparatus of claim 37, wherein each cup has four slits spaced generally evenly.

39. The apparatus of claim 38, wherein the four slits of each cup are aligned with drainage channels.

40. The apparatus of claim 30, wherein the drainage channels gradually decrease in elevation toward the receptacle.

41-44. (canceled)

45. A method of cooking a meat patty with a meat patty apparatus, the method comprising the steps of:
a. placing a quantity of meat in a cup of a cooking tray, wherein the cup has at least one slit at the base thereof;
b. arranging the quantity of meat into the shape of a patty;
c. positioning the cooking tray relative to a reservoir tray such that the at least one slit is generally aligned with at least one drainage channel of the reservoir tray; and
d. placing the positioned cooking tray and reservoir tray in an oven for cooking, wherein excess fat and grease is permitted to escape via the at least one slit of the cup and is carried to a receptacle via the at least one drainage channel.

46-47. (canceled)
